(19) United States
(12) Patent Application Publication
(10) Pub. No.: US 2011/0207612 A1
(43) Pub. Date: Aug. 25, 2011

(54) COPY NUMBER VARIATIONS DETECTING APPARATUS AND METHOD

(75) Inventors: Sang Hyun PARK, Seoul (KR); Chihyun Park, Seoul (KR); Jae Gyoon Ahn, Seoul (KR); Young Mi Yoon, Seoul (KR)

(73) Assignee: Industry-Academic Cooperation Foundation, Yonsei University, Seoul (KR)

(21) Appl. No.: 12/712,162

(22) Filed: Feb. 24, 2010

(30) Foreign Application Priority Data
Feb. 19, 2010 (KR) 10-2010-0015333

(51) Int. Cl. C40B 20/00; C40B 60/10

(52) U.S. Cl. 506/2; 506/38

(57) ABSTRACT

A copy number variations detecting apparatus and method according to at least one embodiment of the present invention compare column vectors adjacent to each other on array comparative genomic hybridization data (aCGH data) and compartmentalize the aCGH data into a plurality of segments according to the comparison results, compare row vectors within the segments for each segment and reconfigure the segments into a predetermined number of clusters according to the comparison results, selectively determine the segments as a candidate copy number variation zone corresponding to a distribution form of the clusters for each segment, detect the CNVs within the candidate CNVZ for each sample, and perform merging and pruning on the candidate CNVZ(s) to obtain a final CNVZ(s).

### BACKGROUND OF THE INVENTION

1. Field of the Invention

The present invention relates to a genome, and more particularly, to a copy number variations detecting method on array Comparative Genomic Hybridization data (referred to as aCGH data).

2. Description of the Related Art

Array Comparative Genomic Hybridization (aCGH) data mean data in an array form that indicates expression values for each probe of genomes and each of a plurality of samples.

Among these expression values, the expression value that exceeds a threshold value is referred to as the copy number variation (CNV). Meanwhile, rapidly and accurately detecting the CNVs on the aCGH data is very important in measuring the expression degree of a chromosome but a current detecting method has limitations in detecting the CNVs in high-precision aCGH data, in particular, detecting the CNVs having a small size.

### SUMMARY OF THE INVENTION

An object of the present invention is to provide a copy number variations detecting apparatus capable of rapidly and accurately detecting copy number variations having a small size in high-precision array comparative genomic hybridization data.

Another object of the present invention is to provide a copy number variations detecting method capable of rapidly and accurately detecting copy number variations having a small size in high-precision array comparative genomic hybridization data.

Yet another object of the present invention is to provide a recording medium readable with a computer and stored with computer programs to run a copy number variations detecting method, which can rapidly and accurately detect copy number variations having a small size in high-precision array comparative genomic hybridization data, with the computer.

In order to achieve the above object, according to an exemplary embodiment of the present invention, there is provided a copy number variations detecting apparatus, including: a compartment unit that compares adjacent column vectors on array comparative genomic hybridization data, which indicate expression values for each probe of genomes and each of a plurality of samples, and compartmentalizes the array comparative genomic hybridization data into a plurality of segments according to the comparison results; a clustering unit that compares row vectors within the segments for each segment and reconfigures the segments into a predetermined number of clusters; and a determination unit that selectively determines the segments as a copy number variation zone according to a distribution form of the clusters, for each segment.

The copy number variations detecting apparatus may detect the copy number variations for each sample in the copy number variation zone.

The compartment unit may selectively break the adjacent column vectors in consideration of the correlation and distance between the adjacent column vectors to compartmentalize the array comparative genomic hybridization data into the segments.

The clustering unit may group the row vectors having adjacent values for each segment to generate the predetermined number of clusters. At this time, the clustering unit may compare representative values for each row vector and group the row vectors having similar representative values in a predetermined range, for each segment, to generate the predetermined number of clusters.

The copy number variations detecting apparatus further includes a smoothing unit that removes noise on the array comparative genomic hybridization data, wherein the array comparative genomic hybridization data given in the compartment unit may be array comparative genomic hybridization data where the noise is removed. At this time, the smoothing unit may replace the expression values of the probes with the representative values of the expression values of the predetermined number of probes including the probes for each sample to remove the noise.

The determination unit may determine the segment as a candidate copy number variations zone in consideration of a sum of absolute values from the differences between central values of each cluster within the segments for each segment. At this time, the determination unit may perform merging and pruning on the candidate copy number variations zone to obtain a final copy number variations zone.

In order to achieve another object, according to an exemplary embodiment of the present invention, there is provided a copy number variations detecting method, including: comparing adjacent column vectors on array comparative genomic hybridization data, which indicate expression values for each probe of genomes and each of a plurality of samples, and compartmentalizing the array comparative genomic hybridization data into a plurality of segments according to the comparison results; comparing row vectors within the segments for each segment and reconfiguring the segments into a predetermined number of clusters; and selectively determining the segments as a copy number variations area corresponding to a distribution form of the clusters, for each segment.

The copy number variations detecting method may further include detecting the copy number variations for each sample in the copy number variations zone.

The compartmentalizing may break the adjacent column vectors in consideration of the correlation and distance between the adjacent column vectors to compartmentalize the array comparative genomic hybridization data into the segments.

The reconfiguring may group the row vectors having adjacent values for each segment to generate the predetermined number of clusters. At this time, the reconfiguring may compare representative values for each row vector and group the row vectors having similar representative values in a predetermined range, for each segment, to generate the predetermined number of clusters.

The copy number variations detecting method may further include removing noise on the array comparative genomic hybridization data, wherein the array comparative genomic hybridization data given in the compartmentalizing may be array comparative genomic hybridization data where the noise is removed. At this time, the removing may replace the expression values of the probes with the representative values of the expression values of the predetermined number of probes including the probes for each sample to remove the noise.

The determining may determine the segment as a candidate copy number variations zone in consideration of a sum of absolute values from the differences between central values of each cluster within the segments for each segment. At this time, the determining may perform merging and pruning on the candidate copy number variations zone to obtain a final copy number variations zone.

In order to achieve yet another object, according to an exemplary embodiment of the present invention, there is provided a recording medium readable with a computer and stored with computer programs to run a copy number variations detecting method with the computer, the copy number variations detecting method including: comparing adjacent column vectors on array comparative genomic hybridization data, which indicate expression values for each probe of genomes and each of a plurality of samples, and compartmentalizing the array comparative genomic hybridization data into a plurality of segments according to the comparison results; comparing row vectors within the segments for each segment and reconfiguring the segments into a predetermined number of clusters; and selectively determining the segments as a copy number variations area corresponding to a distribution form of the clusters, for each segment.

According to the exemplary embodiments of the present invention, it can rapidly and accurately perform the copy number variations even in the case of detecting the copy number variations having a small size in the high-precision array comparative genomic hybridization data, thereby making it possible to rapidly and accurately measure the expression degree of the genome.

### BRIEF DESCRIPTION OF THE DRAWINGS

FIG. 1 is a diagram for explaining array comparative genomic hybridization data;

FIG. 2 is a diagram for explaining CNV, CNVR, CNVE, and CNVZ;

FIG. 3 is a block diagram showing a CNV detecting apparatus according to at least one embodiment of the present invention;

FIG. 4 is a diagram for explaining raw data of array comparative genomic hybridization data;

FIGS. 5 and 6 are diagrams for explaining in detail an operation of a smoothing unit shown in FIG. 3;

FIGS. 7 and 8 are diagrams for explaining an operation of a compartment unit shown in FIG. 3;

FIGS. 9 and 10 are diagrams for explaining an operation of a clustering unit shown in FIG. 3;

FIG. 11 is a diagram for explaining an operation of a determination unit shown in FIG. 3; and

FIG. 12 is a flowchart showing a CNV detecting method according to at least one embodiment of the present invention.

### DETAILED DESCRIPTION OF THE PREFERRED EMBODIMENTS

In order to fully understand the operational advantages and objects to be achieved by exemplary embodiments of the present invention, the exemplary embodiments of the present invention will be described with reference to the accompanying drawings and the contents describing the accompanying drawings.

Hereinafter, a copy number variation detecting apparatus and method according to at least one embodiment of the present invention will be described with reference to the accompanying drawings.

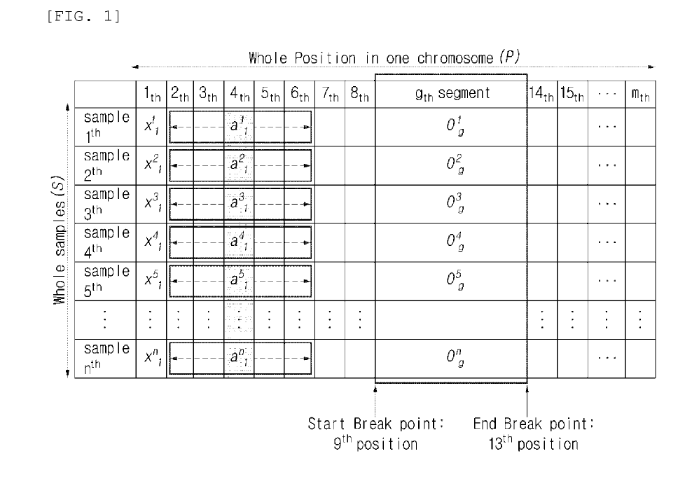

FIG. 1 is a diagram for explaining array comparative genomic hybridization data.

As described above, the array comparative genomic hybridization (aCGH) may be referred to as data, which mean data in an array form that represent “expression values” for ‘each probe of genomes’ and ‘for each of a plurality of samples’. In the specification, the ‘probe’, which is a piece of the genome mounted on a DNA chip, means a basic unit that is mounted on a chip and the ‘sample’ means the genome of any organism (for example, human body), wherein these samples are broken into several probes and each of the probes is mounted on the chip.

As shown in FIG. 1, each row in the array comparative genomic hybridization data means individual samples and each column means individual probes. In FIG. 1, one genome (P) is broken into m probes (however, m is an integer number of two or more) and the array comparative genomic hybridization data are data for a total of n samples (however, n is an integer number of two or more) and represents the expression values for each of the probes for each sample. As shown in FIG. 1, x₁^{p} (however, p is an integer number that is 1≦p≦n) represents the expression value of a first probe of p-th sample, a₁^{p} represents the expression value of a fourth probe of p-th sample, and o_{g}^{p} represents the expression value of a g-th (however, g is an integer that is 1≦g≦m) probe of p-th sample.

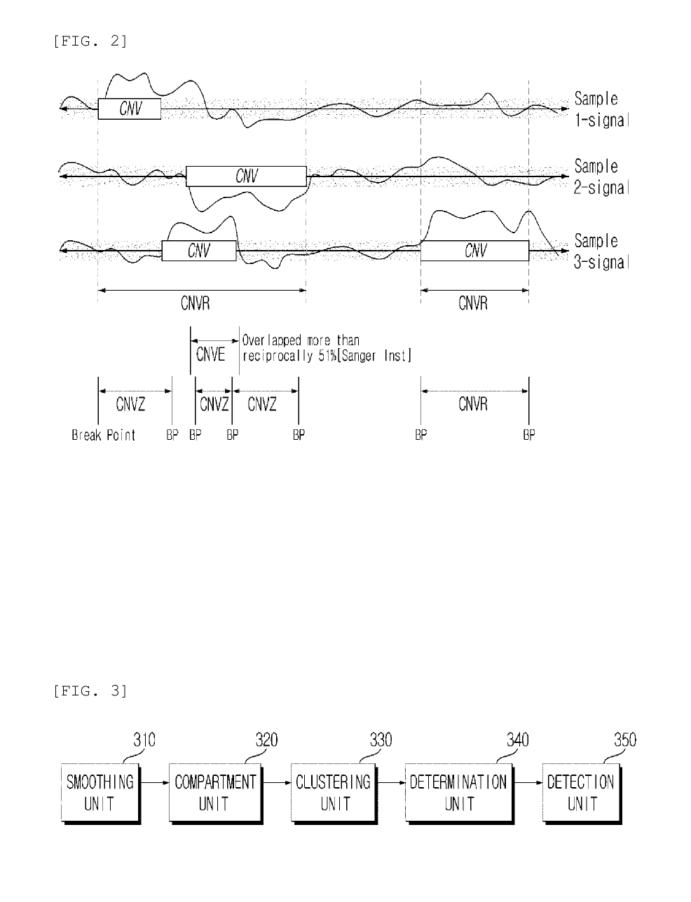

FIG. 2 is a diagram for explaining CNVs, CNVR, CNVE, and CNVZ. For convenience of explanation, FIG. 2 describes only 3 samples. However, the same description can be applied to 40 samples as shown in FIG. 1.

The CNVs represents copy number variation ‘s’, the CNVR represents a period where only one of the samples has the CNVs, the CNVE represents a period where the samples are overlapped 51% or more between the CNVs, and the CNVZ represents a ‘copy-number variations zone’ according to at least one embodiment of the present invention. A method for determining the copy number variations zone will be described with reference to FIGS. 3 to 12.

At least one embodiment of the present invention determines a ‘candidate CNVZ’ and then, determines the ‘copy number variations’ on the ‘array comparative genomic hybridization data’ within the determined ‘candidate CNVZ’ and performs merging and pruning to be described later on the determined ‘candidate CNVZ’ to determine a ‘final CNVZ’.

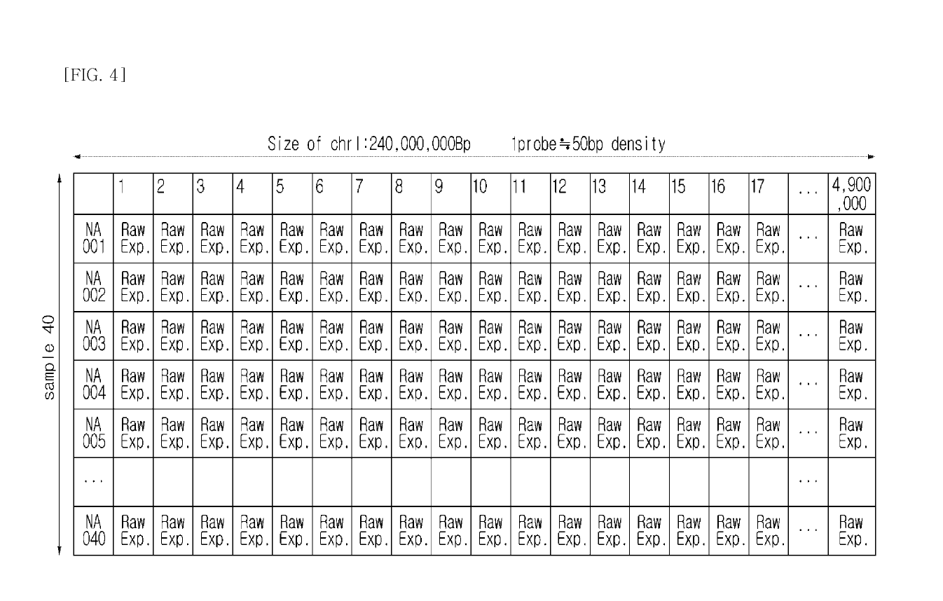

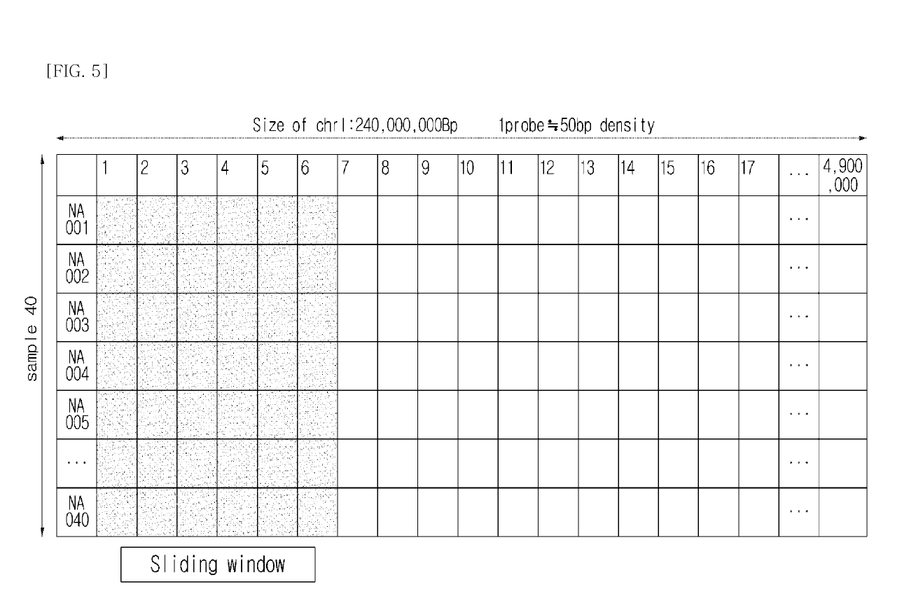

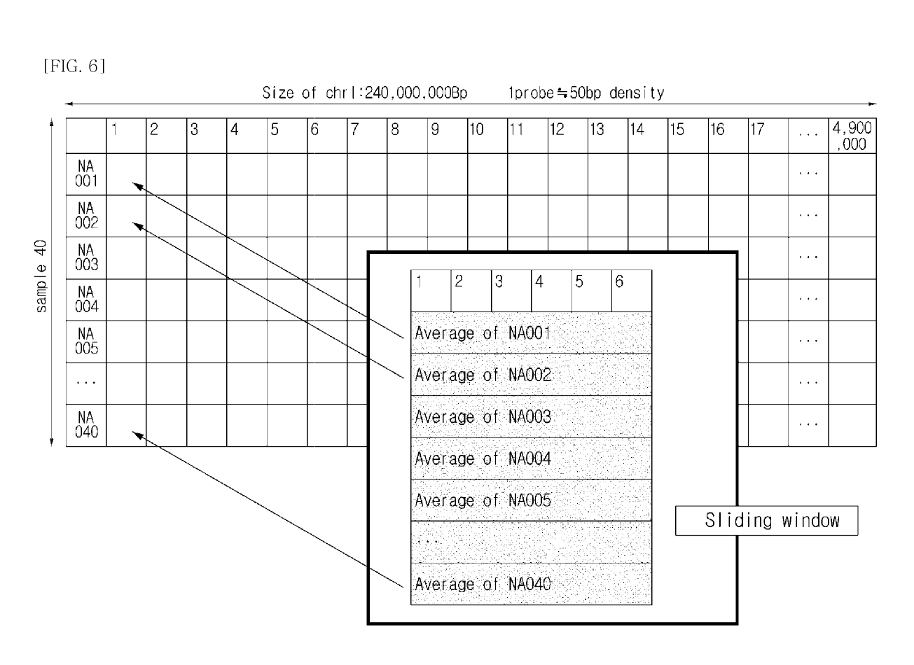

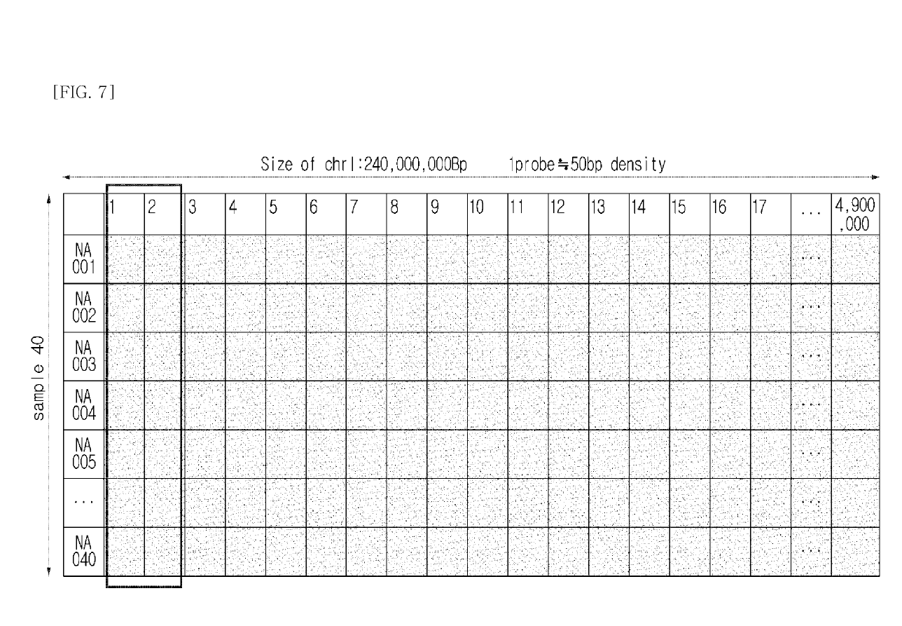

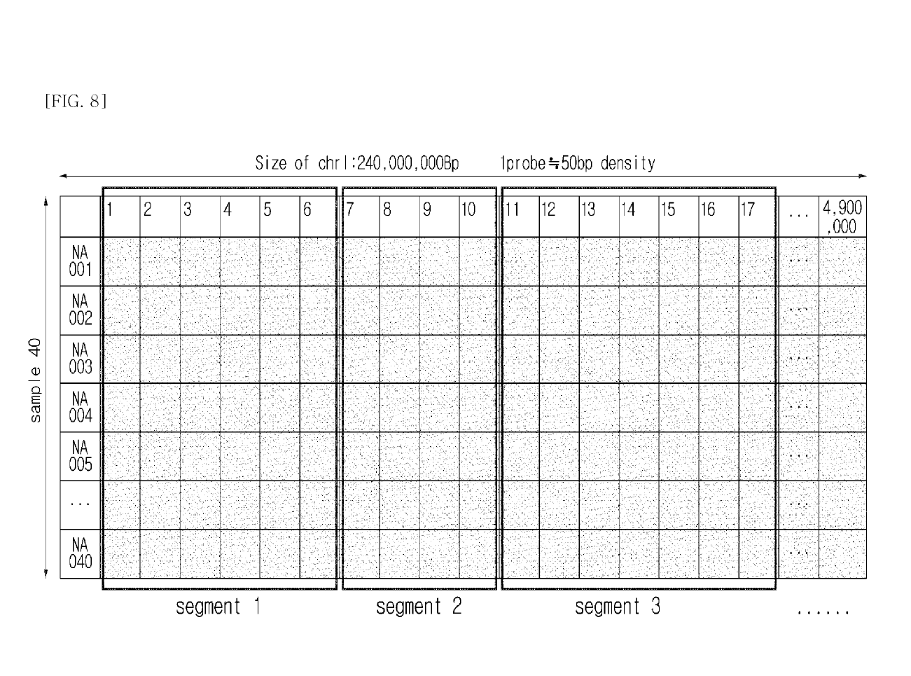

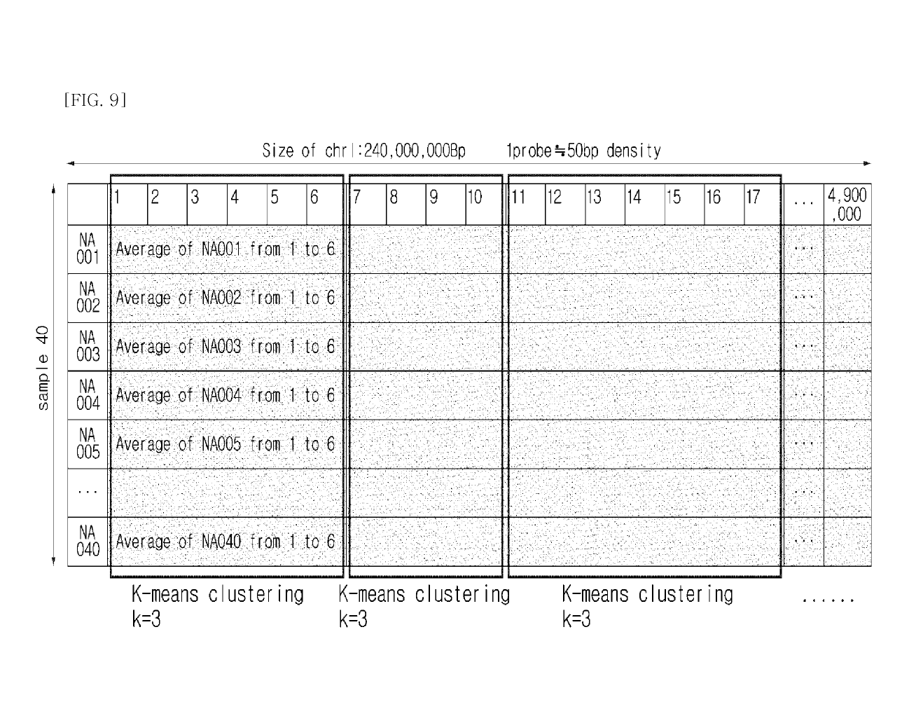

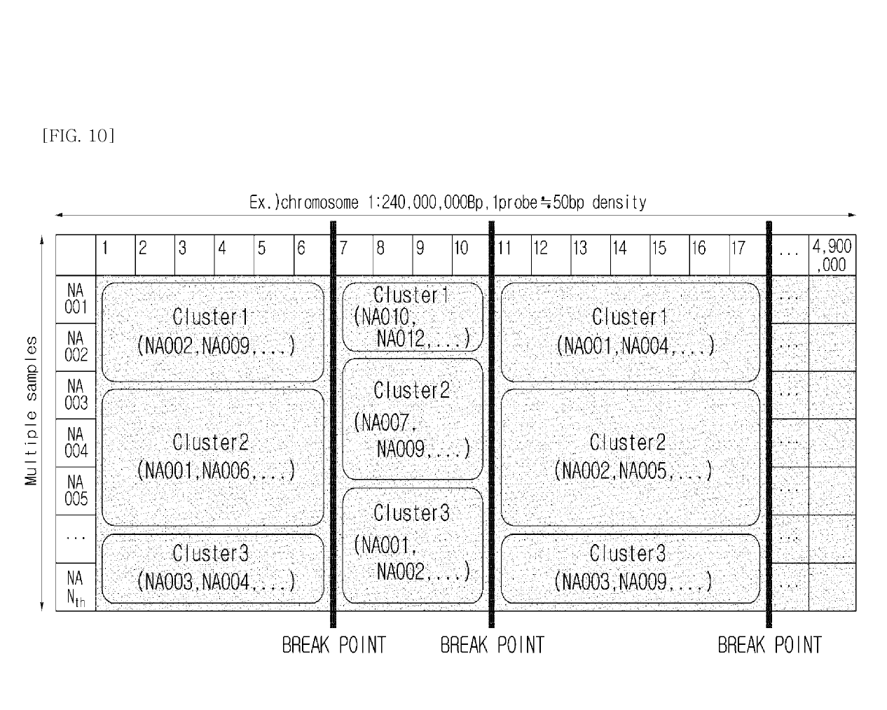

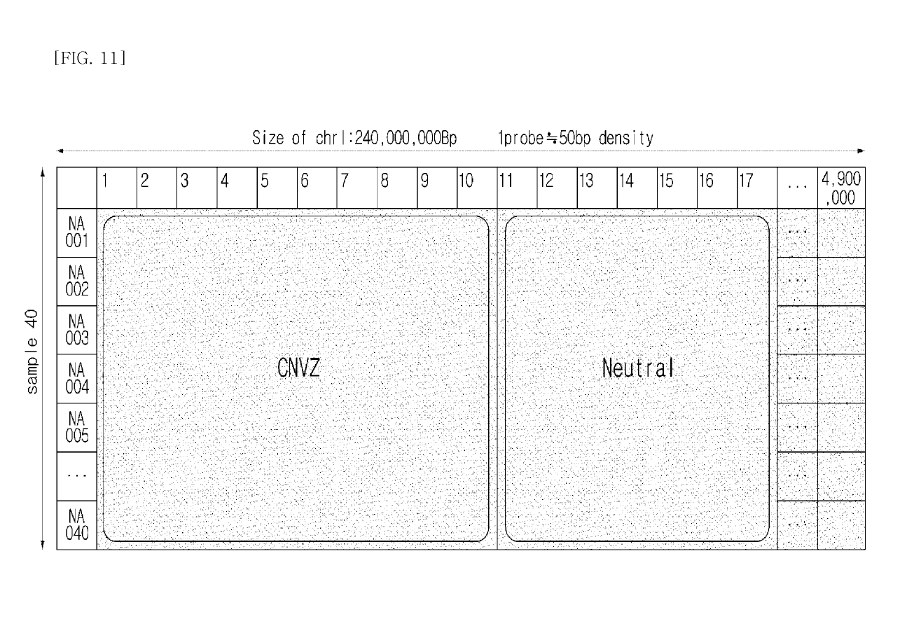

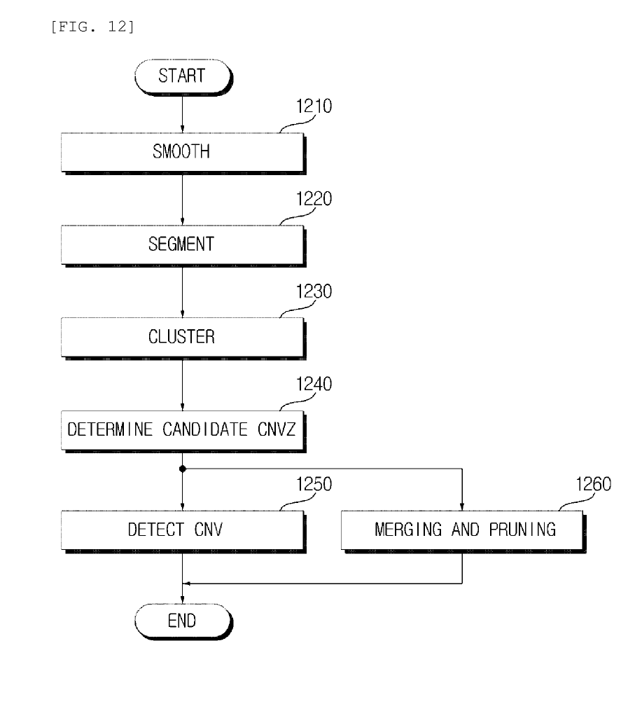

FIG. 3 is a block diagram showing a copy number variations detecting apparatus according to at least one embodiment of the present invention, FIG. 4 is a diagram for explaining raw data of array comparative genomic hybridization data, FIGS. 5 and 6 are diagrams for explaining in detail an operation of a smoothing unit shown in FIG. 3, FIGS. 7 and 8 are diagrams for explaining an operation of a compartment unit shown in FIG. 3, FIGS. 9 and 10 are diagrams for explaining an operation of a clustering unit shown in FIG. 3, and FIG. 11 is a diagram for explaining an operation of a determination unit shown in FIG. 3.

As shown in FIG. 3, the copy number variations detecting apparatus according to at least one embodiment of the present invention may include a smoothing unit 310, a compartment unit 320, a clustering unit 330, a determination unit 340, and a detection unit 350. Hereinafter, the copy number variations detecting apparatus of FIG. 3 will be described in detail with reference to FIGS. 4 to 11.

The smoothing unit 310 removes noise that exists on the array comparative genomic hybridization data. The raw data of the aCGH data will be described with reference to FIG. 4 and FIGS. 5 to 11 are diagrams for explaining the aCGH data of FIG. 4. FIG. 4 shows the expression values for each genome for 40 samples, wherein each genome includes 4,900,000 probes each of which represents the expression values. In FIG. 4, ‘size of chr1 240,000,000 bp’ represents that a size of a chromosome is 240,000,000 base pair and ‘1probe □ 50 bp density’ represents that a length of one probe is a length covering approximately 50 base pair.

In detail, the smoothing unit 310 performs a process, which replaces ‘an expression value of any one probe’ with a representative value of the expression values of a predetermined number of probes including any one probe, on all the probes for each sample to remove the noise on the aCGH data. Herein, the predetermined number of probes including any one of the probes represents a predetermined number of probes adjacent to any one of the probes and the ‘representative value’ is assumed to be an ‘average value’ for convenience of explanation. Describing this with reference to FIGS. 5 and 6, the smoothing unit 310 replaces the expression values corresponding to the ‘first probe’ with an ‘average value of 6 expression values corresponding to a first probe to a sixth probe’ for each sample (that is, the expression value of the first probe of the first sample is replaced with the average value from the expression values of the first to sixth probes of the first sample and the expression value of the first probe of the second sample is replaced with the average value from the expression values of the first to sixth probes of the first sample, etc.) in the state where a sliding window that is a window in a matrix form of 6*40 is positioned as shown in FIG. 5, moves the sliding window to the right by 1 probe, and then, replaces the expression value corresponding to ‘the second probe’ with the average value of 6 expression values corresponding to ‘the second probe to the seventh probe’. As described above, a series of process can be applied to all the probes on the aCGH data to remove all the noises on the aCGH data. The sliding window having a size shown in FIGS. 5 and 6 is a sliding window having a predetermined size for convenience of explanation. Therefore, various modification of the sliding window can be possible.

The smoothing unit 310 may be included in the CNVs detecting apparatus according to one exemplary embodiment of the present invention as shown in FIG. 3 and may not be included unlike shown in FIG. 3.

The compartment unit 320 compares the column vectors adjacent to each other on the aCGH data and compartmentalizes the aCGH data into a plurality of segments according to the comparison results. In the specification, the column vector represents a column vector on the aCGH data, that is, a vector that represents the expression values in each of all the samples for the same probe. In the same principle, the row vector to be described later represents a row vector on the aCGH data, that is, a vector that represents the expression values in each of all the probes for the same sample.

In other words, the compartment unit 320 compares a q-th column vector (however, q represents 1≦q<4,900,000) with a (q+1)-th column vector and determines whether to break between the q-th column vector and the (q+1)-th column vector in consideration of the comparison results. When the compartment unit 320 performs the break according to the above-mentioned determination, each of the broken zones becomes a ‘segment’.

In detail, the compartment unit 320 selectively divides between the adjacent column vectors in consideration of the correlation and distance between the adjacent column vectors for ‘each adjacent column vectors on the aCGH data’ and compartmentalizes the aCGH data into the plurality of segments. Herein, the correlation represents a correlation coefficient between the adjacent column vectors, the column vectors have a positive correlation relationship as going to 1 and have a negative correlation relationship as going to −1 and 0 represents no correlation relationship between the column vectors. Pearson's Correlation Coefficient (PCC) is an example of the ‘correlation’. In addition, the ‘distance’ between the adjacent column vectors represents a relative distance between the adjacent column vectors and a ‘Euclidean distance’ is an example of the ‘distance’.

In more detail, the compartment unit 320 does not break between the adjacent column vectors in the case where the distance between the adjacent column vectors is less than a (predetermined) threshold distance and the correlation between the adjacent column vectors is the threshold correlation or more. On the other hand, in other cases, that is, in the case where the distance between the adjacent column vectors is the threshold distance or more and the distance between the adjacent column vectors is the threshold correlation or more, in the case where the distance between the adjacent column vectors is less than the threshold distance and the correlation between the adjacent column vectors is less than the threshold correlation, and in the case where the correlation between the adjacent column vectors is less than the threshold correlation, the compartment unit 320 breaks between the adjacent column vectors. In FIG. 7, ‘the adjacent column vectors’ represents ‘the first column vector and the second column vector (a portion bound in a rectangle in FIG. 7), ‘the second column vector and the third column vector’, ‘the third column vector and the fourth column vector’, . . . , respectively. FIG. 8 shows one example of the segments generated by the compartment unit 320 and shows the segments that are broken between the sixth column vector and the seventh column vector and are broken between the tenth column vector and the eleventh column vector.

The clustering unit 330 compares the row vector within the segments for each ‘segment’ and reconfigures the segments into a predetermined number of clusters according to the comparison results.

In detail, the clustering unit 330 groups the row vectors having the adjacent values to each other for each ‘segment’ to generate the predetermined number of clusters. In more detail, the clustering unit 330 compares the representative value of each row vector for each segment and groups the row vectors having the representative value similar to each other within the predetermined range to generate the predetermined number of clusters. The operation of the clustering unit 330 for ‘segment 1’ will be described with reference to FIG. 9. The clustering unit 330 compares ‘the average value of the expression values of the first to sixth probes of the first sample’, ‘the average value of the expression values of the first to sixth probes of the second sample’, ‘the average value of the expression values of the first to sixth probes of the third sample’, . . . , ‘the average value of the expression values of the first to sixth probes of the fortieth sample’ to group the group vectors similar to each other, thereby making it possible to generate the clusters as shown in FIG. 10. FIG. 10 shows the case where segment 1 is reconfigured as cluster 0, cluster 1, and cluster 2. At this time, cluster 0 represents the combination of the row vectors of the second sample, the ninth sample, and so on, cluster 1 represents the combination of the row vectors of the first sample, the sixth sample, and so on, and the cluster 2 represents the combination of the row vectors of the third sample, the fourth sample, and so on.

The clustering unit 330 may be operated according to the so-called ‘K-means clustering method’ (K=3 in the case of FIGS. 9 and 10).

The determination unit 340 selectively determines the segment as the CNVZ′ corresponding to the distribution form of the clusters in the segment for each ‘segment’. In other words, the determination unit 340 may determine the segment as the CNVZ in consideration of the distribution form of the clusters within the segment or may not determine the segment as the CNVZ.

In detail, the determination unit 340 may determine the segment as the candidate CNVZ in consideration of the sum of the absolute values of the difference between the central values of each cluster within the segment for each ‘segment’. Herein, the central value of the cluster represents the average value of the expression values within the cluster. The ‘sum’ may be represented by the following Equation 1.

$$SC ( {seg}_{g } ) = α {\sum }_{i = 1}^{k - 1} {\sum }_{j = i + 1}^{k} \vert {C}_{i} - {C}_{j} \vert , i \neq j and i , j \leq k . \qquad [ Equation 1 ]$$

Where k is K at the K-means clustering method’, i and j are each a cluster, Ci and Cj are each the central value of the i-th cluster and the central value of the j-th cluster, and α is a proportional coefficient. The operation of the determination unit 340 for segment 1 will be described with reference to FIG. 10 and Equation 1. In the case of segment 1, the remaining terms other than α at the right terms of Equation 1 is a sum of the difference between the central value of cluster 0 and the central values of cluster 1′ and the difference between the central value of cluster 0 and the central values of cluster 2′ in segment 1. If the ‘sum’ is large, an SC (that is, score) is also large and as the SC is getting larger, the clusters are away from each other. If so, since the samples are very likely to have the highly positive expression values, the determination unit 340 determines segment 1 as the candidate CNVZ, when the SC for segment 1 exceeds the threshold value. Even when all the central values of the clusters within segment 1 have a highly negative value, the value may be still represented highly by the amendment through an a value. Therefore, if the SC for segment 1 exceeds the threshold value, the determination unit 340 may determine segment 1 as the candidate CNVZ.

The determination unit 340 performs the merging and the pruning on the candidate CNVZ to obtain the final CNVZ. Herein, the merging sums up the candidate CNVZs when the blank between the adjacent candidate CNVZs is a predetermined length or less (for example, 500 Bp (base pair)) and determines all the candidate CNVZs from start to end as the final CNVZ. This is performed in consideration of the possibility that there may be experimental errors in the aCGH data and the possibility that since there is a portion when the intermediate experiment is not performed well even when the hybridization experiment is performed by uniformly cutting off the chromosome, the portion may approach 0 even though the CNVs show very high positive or negative values. Meanwhile, the pruning does not recognize the candidate CNVZ as the CNVs when the length of the candidate CNVZ is a predetermined length (for example, 500 base pair) or less but regards it as the experimental error to be removed, such that it does not take the candidate CNVZ as the final CNVZ. This is a process performed according to the fact that the smallest unit of the CNV is known to have a length up to approximately 500 Bp. Of course, the ‘predetermined length’ that is a reference of whether the pruning is performed may be set by the user.

The detection unit 350 detects the CNV in the candidate CNVZ for each sample.

FIG. 12 is a flowchart showing the CNVs detecting method according to at least one embodiment of the present invention.

The CNVs detecting apparatus according to at least one embodiment of the present invention removes the noise existing on the aCGH data (step 1210). However, step 1210 may not be included in the CNVs detecting method according to at least one embodiment of the present invention. After step 1210 or without passing through step 1210, the CNVs detecting apparatus according to at least one embodiment of the present invention compares the column vectors adjacent to each other on the aCGH data and compartmentalizes the aCGH data into the plurality of segments according to the comparison results (step 1220).

After step 1220, the CNVs detecting apparatus according to at least one embodiment of the present invention compares the row vectors within the segments for each segment and reconfigures the segments into the predetermined number of clusters according to the comparison results (step 1230).

After step 1230, the CNVs detecting apparatus according to at least one embodiment of the present invention selectively determines the segment as the candidate CNVZ corresponding to the distribution form of the clusters within the segments for each segment (step 1240).

If it is determined that the segment is determined as the candidate CNVZ at step 1240, the CNVs detecting apparatus according to at least one embodiment of the present invention detects the CNVs for each sample in the candidate CNVZ determined at step 1240 (step 1250).

After step 1240, the CNVs detecting apparatus according to at least one embodiment of the present invention performs the merging and the pruning on the determined candidate CNVZ(s) determined at step 1240 to obtain the final CNVZ(s) (step 1260).

Programs to run the above-mentioned CNVs detecting method according to the present invention with a computer may be stored in a recording medium readable with the computer.

Herein, the recording medium readable with the computer includes a storage medium such as a magnetic storage medium (for example, ROM, floppy disc, hard disc, etc.) and an optical reading medium (for example, CD-ROM, digital versatile disc (DVD)).

Hitherto, the present invention was described based on the exemplary embodiments. It will be appreciated by those skilled in the art that various modifications, changes, and substitutions can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A copy number variations detecting apparatus, comprising:
a compartment unit that compares adjacent column vectors on array comparative genomic hybridization data, which indicate expression values for each probe of genomes and each of a plurality of samples, and compartmentalizes the array comparative genomic hybridization data into a plurality of segments according to the comparison results;
a clustering unit that compares row vectors within the segments for each segment and reconfigures the segments into a predetermined number of clusters; and
a determination unit that selectively determines the segments as a copy number variation zone according to a distribution form of the clusters, for each segment.

2. The copy number variations detecting apparatus according to claim 1, wherein the copy number variations detecting apparatus detects the copy number variations for each sample in the copy number variation zone.

3. The copy number variations detecting apparatus according to claim 1, wherein the compartment unit selectively breaks the adjacent column vectors in consideration of the correlation and distance between the adjacent column vectors to compartmentalize the array comparative genomic hybridization data into the segments.

4. The copy number variations detecting apparatus according to claim 1, wherein the clustering unit groups the row vectors having adjacent values for each segment to generate the predetermined number of clusters.

5. The copy number variations detecting apparatus according to claim 4, wherein the clustering unit compares representative values for each row vector and group the row vectors having similar representative values in a predetermined range, for each segment, to generate the predetermined number of clusters.

6. The copy number variations detecting apparatus according to claim 1, wherein the copy number variations detecting apparatus further includes a smoothing unit that removes noise on the array comparative genomic hybridization data, wherein the array comparative genomic hybridization data given in the compartment unit are array comparative genomic hybridization data where the noise is removed.

7. The copy number variations detecting apparatus according to claim 6, wherein the smoothing unit replaces the expression values of the probes with the representative values of the expression values of the predetermined number of probes including the probes for each sample to remove the noise.

8. The copy number variations detecting apparatus according to claim 1, wherein the determination unit determines the segment as a candidate copy number variations zone in consideration of a sum of absolute values of differences between central values of each cluster within the segments for each segment.

9. The copy number variations detecting apparatus according to claim 8, wherein the determination unit performs merging and pruning on the candidate copy number variations zone to obtain a final copy number variations zone.

10. A copy number variations detecting method, comprising:
comparing adjacent column vectors on array comparative genomic hybridization data, which indicate expression values for each probe of genomes and each of a plurality of samples, and compartmentalizing the array comparative genomic hybridization data into a plurality of segments according to the comparison results;
comparing row vectors within the segments for each segment and reconfiguring the segments into a predetermined number of clusters; and
selectively determining the segments as a copy number variations area corresponding to a distribution form of the clusters within the segments, for each segment.

11. The copy number variations detecting method according to claim 10, wherein the copy number variations detecting method further includes detecting the copy number variations for each sample in the copy number variations zone.

12. The copy number variations detecting method according to claim 10, wherein the compartmentalizing selectively breaks the adjacent column vectors in consideration of the correlation and distance between the adjacent column vectors to compartmentalize the array comparative genomic hybridization data into the segments.

13. The copy number variations detecting method according to claim 10, wherein the reconfiguring groups the row vectors having adjacent values for each segment to generate the predetermined number of clusters.

14. The copy number variations detecting method according to claim 13, wherein the reconfiguring compares representative values for each row vector and groups the row vectors having similar representative values in a predetermined range, for each segment, to generate the predetermined number of clusters.

15. The copy number variations detecting method according to claim 10, wherein the copy number variations detecting method further includes removing noise on the array comparative genomic hybridization data, wherein the array comparative genomic hybridization data given in the compartmentalizing are array comparative genomic hybridization data where the noise is removed.

16. The copy number variations detecting method according to claim 15, wherein the removing replaces the expression values of the probes with the representative values of the expression values of the predetermined number of probes including the probes for each sample to remove the noise.

17. The copy number variations detecting method according to claim 10, wherein the determining determines the segment as a candidate copy number variations zone in consideration of a sum of absolute values of differences between central values of each cluster within the segments for each segment.

18. The copy number variations detecting method according to claim 17, wherein the determining performs merging and pruning on the candidate copy number variations zone to obtain a final copy number variations zone.

19. A recording medium readable with a computer stored with computer programs to execute a method according to claim 10.
